(19) United States
(12) Patent Application Publication
(10) Pub. No.: US 2021/0019838 A1
(43) Pub. Date: Jan. 21, 2021

(54) PUBLIC OBJECT RECHECKING SYSTEM AND USER INTERFACES THEREOF

(71) Applicant: CHE SHENG KUNG, Taipei (TW)

(72) Inventor: CHE SHENG KUNG, TAIPEI (TW)

(21) Appl. No.: 16/515,027

(22) Filed: Jul. 18, 2019

(51) Int. Cl. G06Q 50/00; G06F 9/451; G07C 13/00

(52) U.S. Cl. CPC G06Q 50/01; G07C 13/00; G06F 9/451

(57) ABSTRACT

The invention provides a public object rechecking system, including: a user identification unit, identifying a plurality of users for entering the system; an object collector, located on a server for collecting at least one object which is publicly focused; a user interface, configured to present the object to the identified users in a discussion block for collecting objections to the object, wherein the object is determined to be accepted or denied, according to the objections; and a bulletin, configured to announce the object determined to be accepted.

### BACKGROUND OF THE INVENTION

### Field of Invention

The present invention relates to a public object rechecking system, especially a public opinion system determining objects to be accepted or denied, according to objections to the objects.

### Description of Related Art

In a freely expressing personal opinion environment (for example, internet), fake news is troublesome and difficult to avoid. Furthermore, identifying fake news is usually very expensive and time-consuming. To solve this problem, artificial intelligence is a current technology focus. However, artificial intelligence is difficult to determine the authenticity of an object (for example, news, or an internet article), because the authenticity determination is complicated. Artificial intelligence can only judge the authenticity based on simple known facts instead of logically reasoning; for example, the earth is spherical, sun rises in the east and sets in the west, two plus two equals four, etc.

When common readers read a publicly focused news, the related objections from some readers are usually ignored by others. Because, the common readers are not willing to take time to go through the discussion details, and there is usually no efficient determination process for the readers to judge the authenticity. Therefore, cyberbully happens more and more often in a global scale; even in some cases, it becomes offensive to cause a tragedy. A trustworthy public forum is very important for helping people to identify possible fake news.

Besides, please refer to FIG. 1, which illustrates a prior operation between the object (e.g. news, internet article) and related feedbacks to this object in the public forum. The feedbacks from the readers are at will and diversely distributed, such that reading the feedbacks becomes very tough. Moreover, the feedbacks can include several similar contents, causing that the readers are less interested to go through all of the feedbacks. Therefore, some important messages in the feedbacks are ignored.

### SUMMARY OF THE INVENTION

In view of the above, the present invention provides a public object rechecking system, for determining an object to be accepted or denied. In this system, discussion over objections is a key for determining the object to be accepted, wherein the objections are effectively converged into at least one objection tracking routes (for example, the tracking routes in FIGS. 2A and 2C), wherein the objections and/or supports can be an interactive dialectic process in few tracking routes which are much easier for the readers to follow the discussions. In the present invention, when there are no objections on one object, it means two possibilities: this object is not publicly focused, or people is afraid to express objections. No matter which aforementioned possibility is correct, this object is questionable, and should be marked when presented in public (for example, public forum, newspaper, webpage, magazine, social software, etc.), such that the readers should be noticed. For example, the social software can include Facebook, Line, Instagram, Blog, Vlog, etc. In the present invention, the voting and feedback on objects are operated in a semi-close system, and the opinions from the users are systematically and effectively managed by tracking the objections, for largely reducing random and aimless discussions.

Further, the public object rechecking system of the present invention has a function of “question self-feeding and self-verifying”; that is, the system is capable of collecting questions from the object or objections, and verifying the answers by collecting corresponding answers from the users.

In one perspective of the present invention, a public object rechecking system is provided by including: a user identification unit, identifying a plurality of users for entering the system; an object collector, located on a server for collecting at least one object which is publicly focused; a user interface, configured to present the object to the identified users in a discussion block for collecting objections and corresponding discussions from the identified users to the object, and determining the object to be accepted or denied, according to the objections; and a bulletin, configured to announce the object determined to be accepted.

In one embodiment, the identified users log in the public object rechecking system by respective account identification, such as telephone number accounts, or social security numbers.

In one embodiment, the user interface is included in an application software, an electronic device, a webpage, a computer, or a multimedia tool.

In one embodiment, the object collector provides a first object weighting and a second object weighting, according to priority between a first object and a second object recommended by one of the identified users within a time period for presenting the objects in the user interface, wherein the first object weighting is higher than the second object weighting.

In one embodiment, the object is determined to be accepted or not, according to the objections (or the objections and corresponding discussion), which are validated by identified user's voting and corresponding discussions; or, the object is determined to be accepted or not, according to the objections (or the objections and corresponding discussion), which are validated by identified user's voting, corresponding discussions, and endorsement from expert users, who are a plurality of the identified users.

In one embodiment, the user interface provides a question bank, which comprises a predetermined-truth bank, a predetermined-false bank, and a to-determine bank, for respectively storing questions with predetermined-true descriptions, questions with predetermined-false descriptions, and questions with to-determine descriptions. In one embodiment, the user interface provides a test with questions from the predetermined-truth bank, the predetermined-false bank, and the to-determine bank, to the identified users. By answering the questions, the identified users could earn in-system currency or other merits.

In one embodiment, the identified users spend their in-system currency for collecting object, voting, providing objection, or providing support.

In one embodiment, the public object rechecking system collects the questions with to-determine descriptions, by extracting logical descriptions from the object, supports, or the objections. The logical descriptions are then included in the test for collecting corresponding answers from the identified users. When the true or false of the logical descriptions are determined according to the collected answers, the logical descriptions may be classified into the predetermined-truth bank or the predetermined-false bank.

In one embodiment, the public object rechecking system, further comprising a duration period, which starts from the user interface presenting the object, till the object determined to be accepted or denied.

### BRIEF DESCRIPTION OF THE DRAWINGS

For a better understanding of the above and other aspects of the present invention, the following detailed description of the embodiments with reference to the figures.

FIG. 1 illustrates a prior operation of the object and the related feedbacks to this object in a public forum.

FIGS. 2-2E illustrate schematic views of objection tracking routes according to two embodiments of the present invention.

FIGS. 3-3C illustrate schematic views of objection tracking routes according to one embodiment of the present invention.

FIG. 4 illustrates a public object rechecking system according to one embodiment of the present invention.

FIG. 5 illustrates several possible options to collect the objects into the user interface.

FIG. 6 illustrates a schematic flowchart of collecting the objects into the user interface according to one embodiment of the present invention.

FIGS. 7A and 7B, illustrate object rechecking process according to one embodiment of the present invention.

FIG. 8 illustrates a schematic view of two options for discussing the objects according to several embodiments of the present invention

FIG. 9 illustrates two options to obtain the determining decision in the determining unit according to one embodiment of the present invention

FIG. 10 illustrates one schematic view of object rechecking operations in the user interface according to one embodiment of the present invention.

### DESCRIPTION OF THE PREFERRED EMBODIMENTS

The objectives, technical details, features, and effects of the present invention will be better understood with regard to the detailed description of the embodiments below, with reference to the drawings.

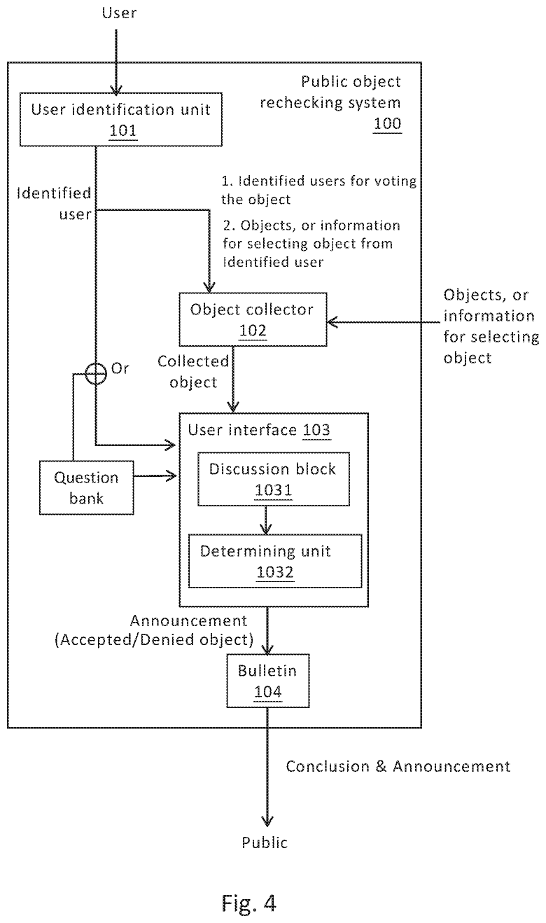

In one perspective of the present invention, please refer to FIG. 4, wherein a public object rechecking system 100 is provided by including: a user identification unit 101, identifying a plurality of users for entering the system; an object collector 102, located on a server for collecting at least one object which is publicly focused; a user interface 103, configured to present the object, objections, and corresponding discussions to the identified users in a discussion block 1031, wherein the objections is determined to be accepted or denied in a determining unit 1032, the determining unit 1032 also configured for internally presenting announcement in the system; and a bulletin 104, configured to announce the object determined to be accepted or not, and to show discussion tracking routes.

In one embodiment, the identified users respectively have registered identification (hereinafter ID) information and phone number stored in the public object rechecking system. When the user applying for new ID in public object rechecking system, the system will send registering phone number to a telecom company, to confirm if the person had registered or not. If answer from the telecom company is yes, after confirming with account owner, a new account is activated after the old one is disabled. This telephone number account design can avoid double accounts of the same one user, and avoid a counterfeit account, without storing important personal information in the system. According to the present invention, not only the telephone number, but also other letters or numbers, can be applied as to identifying the ID (for example, the social security number) of the identified users.

Importantly, the object collector can be located on a server, and the user interface can be included in an application software, an electronic device, a webpage, a computer, or a multimedia tool.

In one embodiment, the object collector 102 collects the publicly focused object based on an internet discussion enthusiastic level, an internet reading enthusiastic level, and/or click rate. Or, the object collector 102 collects objects recommended by the identified users. The object includes article, information, and publication from the public. In one embodiment, the objects collecting can depend on the in-system currency spent by the identified users. For example, the identified user spending higher in-system currency, may have the priority for determining the collected object. If necessary, the aforementioned embodiments of collecting objects may not be operated separately, but in any combination of the aforementioned embodiments.

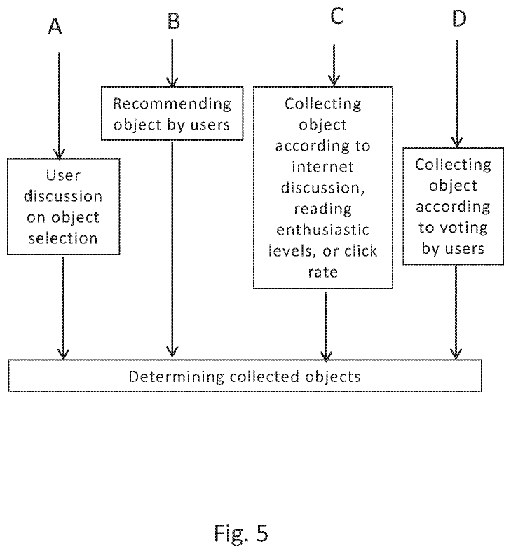

FIG. 5 also illustrates several possible options to collect the objects into the user interface. For example, in option A, the identified user can discuss the candidate objects, and then determining the collected objects based on the identified users' discussion. In option B, the object can be recommended by the user. In option C, collecting object according to internet discussion/reading enthusiastic levels or click rate. In option D, in the aforementioned embodiments, collected objects are determined based on the identified users' voting records. In the present invention, the objects can be collected based on at least one of the options A, B, C, and D.

In one embodiment, when more of the identified users have a bias in favor of the objects of some specific topics, and the collected objects are determined only based on the majority decisions of the more identified users, other important objects voted by the fewer identified users are possibly ignored. The final collected objects do not conform to the principle of voting proportionality. In one embodiment, in order to avoid this deficiency, the present invention further provides a technique, wherein the object collecting can be determined according to a weighted score obtained by an increasing function or a decreasing function. In one embodiment, the function may have a settled characteristics in a concerned functional range. The concerned functional range corresponds to a predetermined range of a parameter in the function. For example, in the tables 2A, 2B, and 2C, the concerned functional range for the parameter n is between 0 and 9, and the function has the settled characteristics. For example, the increasing function can be in a relation of “fⁿ(x)≥x”, wherein the integer n is a parameter for defining the nested function fⁿ(x). For example, f²(x)=f(f(x)) . The decreasing function can be in a form of “F(x)≤x”.

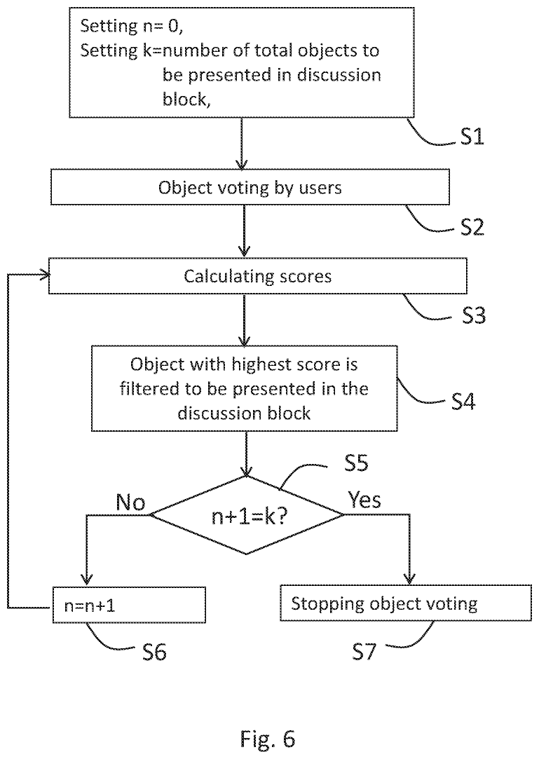

FIG. 6 illustrates a flowchart of this object collecting method. In step S1, determining a number k of total objects to be selected in the user interface 103. The Number n=0 is an initial integer corresponding to a first collected object presented to the discussion block 1031. In step S2, the identified users vote on all collected objects. In step S3, calculating scores of collected objects, based on voting and voting on selected objects. In step S4, collecting at least one of the highest score objects, and removing it (them) in the list of score calculation. In step S5, determining whether to continue collecting objects or to end selecting objects, according to the comparison between k and number of selected object(s) (for example, n+1). In step S6, before continue selecting objects, the value of variable n becomes the number of objects (for example, 1) selected in step S5 plus the original value of variable n, wherein the number of selected object is 1 as shown in FIG. 6. If necessary, the number of selected objects may be more than 1, after determining the scores of selected objects. In step S7, when the collected object is the last, stopping the score calculation.

In one embodiment, the increasing function or the decreasing function can be in a form of multiplying a function value on, to obtain scores for reweighting certain objects. And, the next object (s) are determined to be selected when the objects have larger scores. Two embodiments of the present invention are shown in following tables. In tables 1A and 1B, there are two groups of people (groups P and Q) voted on different 10 objects (totally 20, which is P1˜10 and Q1˜10) separately, and the objects with less “sequence” value will have priority when the voting counts (number of users voting the objects) are the same. Please notice that no matter how many times the minority group (Q) votes their objects, the voting counts by the majority group (P) are higher than the minority group (Q). That is, objects voted by the minority group (Q) have no chance to be selected to the discussion block 1031.

TABLE 1A

| | Objects | | | | | | | | | |
|---|---|---|---|---|---|---|---|---|---|---|
| | P1 | P2 | P3 | P4 | P5 | P6 | P7 | P8 | P9 | P10 |
| Sequence | 1 | 2 | 3 | 4 | 5 | 6 | 7 | 8 | 9 | 10 |
| Voting count | 90 | 90 | 90 | 90 | 90 | 90 | 90 | 90 | 90 | 90 |
| by Group (P) | | | | | | | | | | |
| (totally 90 | | | | | | | | | | |
| users) | | | | | | | | | | |
| Voting count | 0 | 0 | 0 | 0 | 0 | 0 | 0 | 0 | 0 | 0 |
| by Group (Q) | | | | | | | | | | |
| (totally 10 | | | | | | | | | | |
| users) | | | | | | | | | | |

TABLE 1B

| | Objects | | | | | | | | | |
|---|---|---|---|---|---|---|---|---|---|---|
| | Q1 | Q2 | Q3 | Q4 | Q5 | Q6 | Q7 | Q8 | Q9 | Q10 |
| Sequence | 1 | 2 | 3 | 4 | 5 | 6 | 7 | 8 | 9 | 10 |
| Voting count | 0 | 0 | 0 | 0 | 0 | 0 | 0 | 0 | 0 | 0 |
| by Group (P) | | | | | | | | | | |
| (totally 90 | | | | | | | | | | |
| users) | | | | | | | | | | |
| Voting count | 10 | 10 | 10 | 10 | 10 | 10 | 10 | 10 | 10 | 10 |
| by Group (Q) | | | | | | | | | | |
| (totally 10 | | | | | | | | | | |
| users) | | | | | | | | | | |

In one embodiment shown in tables 2A, 2B, and 2C, the voting weighting function is in a functional form of f(n−y)=2^{n-y}, wherein variable n starts with 0; the variable y=number of objects which is both voted n specific identified user and selected to be presented. The calculation table includes three tables, and the tables 2B and 2C are continued tables of table 2A. In the tables 2A, 2B, and 2C, K=10 (number of objects to be presented in discussion block), Group (P) includes ninety users to vote an identical object in each of ten priorities, and Group (Q) includes ten users to vote another identical object in each of the ten priorities, wherein the other ten identical objects (by Group (Q)) are different from the ten identical objects (by Group (P)). In the tables 2A, 2B, and 2C , the function is (2^{n-y})×(number of voting users):

TABLE 2A

| | | f(n − y) | Score | f(n − y) | Score | Largest score, |
|---|---|---|---|---|---|---|
| | Priority | of Group | of Group | of Group | of Group | group with |
| Step | (n) | (P) | (P) | (Q) | (Q) | largest score |
| S1 | Setting n = 0 | | | | | |
| | setting k = 10 (the number of total objects to be presented | | | | | |
| | in discussion block) | | | | | |
| S2 | Object voting by Group (P) and Group (Q) | | | | | |
| S3 | 0 | f(0 − 0) = | 1 × 90 | f(0 − 0) = | 1 × 10 | 90, Group |
| | | 2⁰⁻⁰ = 1 | (users) = 90 | 2⁰⁻⁰ = 1 | (users) = 10 | (P) |
| S4, | Object P1 is selected, | | | | | |
| S5, | the one with least “sequence” value in objects P1~P10 | | | | | |
| S6 | (y = 1 for Group(P), y = 0 for group (Q) for next calculation) | | | | | |
| | n = 0 + 1 = 1 = number of selected objects | | | | | |
| S3 | 1 | f (1 − 1) = | 1 × 90 | f (1 − 0) = | 2 × 10 | 90, Group |
| | | 2¹⁻¹ = 1 | (users) = 90 | 2¹⁻⁰ = 2 | (users) = 20 | (P) |
| S4, | Object P2 is selected, | | | | | |
| S5, | the one with least “sequence” value in objects P2~P10 | | | | | |
| S6 | (y = 2 for Group(P), y = 0 for group (Q) for next calculation) | | | | | |
| | n = 1 + 1 = 2 = number of selected objects | | | | | |
| S3 | | f (2 − 2) = | 1 × 90 | f (2 − 0) = | 4 × 10 | 90, Group |
| | | 2²⁻² = 1 | (users) = 90 | 2²⁻⁰ = 4 | (users) = 40 | (P) |

| | |
|---|---|
| S4, | Object P3 is selected, |
| S5, | the one with least “sequence” value in objects P3~P10 |
| S6 | (y = 3 for Group (P), y = 0 for group (Q) for next calculation) |
| | n = 1 + 2 = 3 = number of selected objects |

TABLE 2B

| S3 | 3 | f(3 − 3) = | 1 × 90 | f(3 − 0) | 8 × 10 | 90, Group |
|---|---|---|---|---|---|---|
| | | 2³⁻³ = 1 | (users) = 90 | =2³⁻⁰ = 8 | (users) = 80 | (P) |
| S4, | Object P4 is selected, | | | | | |
| S5, | the one with least “sequence” value in objects P4~P10 | | | | | |
| S6 | (y = 4 for Group(P), y = 0 for group (Q) for next calculation) | | | | | |
| | n = 3 + 1 = 4 = number of selected objects | | | | | |
| S3 | 4 | f(4 − 4) = | 1 × 90 | f(4 − 0) = | 16 × 10 | 160, Group |
| | | 2⁴⁻⁴ = 1 | (users) = 90 | 2⁴⁻⁰ = 16 | (users) = 160 | (Q) |
| S4, | Object Q1 is selected, | | | | | |
| S5, | the one with least “sequence” value in objects Q1~Q10 | | | | | |
| S6 | (y = 4 for Group(P), y = 1 for group (Q) for next calculation) | | | | | |
| | n = 4 + 1 = 5 = number of selected objects | | | | | |
| S3 | 5 | f(5 − 4) = | 2 × 90 | f(5 − 1) = | 16 × 10 | 180, Group |
| | | 2⁵⁻⁴ = 2 | (users) = 180 | 2⁵⁻¹ = 16 | (users) = 160 | (P) |
| S4, | Object P5 is selected, | | | | | |
| S5, | the one with least “sequence” value in objects P5~P10 | | | | | |
| S6 | (y = 5 for Group(P), y = 1 for group (Q) for next calculation) | | | | | |
| | n = 5 + 1 = 6 = number of selected objects | | | | | |
| S3 | 6 | f(6 − 5) = | 2 × 90 | f(6 − 1) = | 32 × 10 | 320, Group |
| | | 2⁶⁻⁵ = 2 | (users) = 180 | 2⁶⁻¹ = 32 | (users) = 320 | (Q) |

| | |
|---|---|
| S4, | Object Q2 is selected, |
| S5, | the one with least “sequence” value in objects Q2~Q10 |
| S6 | (y = 5 for Group(P), y = 2 for group (Q) for next calculation) |
| | n = 6 + 1 = 7 = number of selected objects |

TABLE 2C

| S3 | 7 | f(7 − 5) = | 4 × 90 | f (7 − 2) = | 32 × 10 | 360, Group |
|---|---|---|---|---|---|---|
| | | 2⁷⁻⁵ = 4 | (users) = 360 | 2⁷⁻² = 32 | (users) = 320 | (P) |
| S4, | Object P6 is selected, | | | | | |
| S5, | the one with least “sequence” value in objects P6~P10 | | | | | |
| S6 | (y = 6 for Group(P), y = 2 for group (Q) for next calculation) | | | | | |
| | n = 7 + 1 = 8 = number of selected objects | | | | | |
| S3 | 8 | f(8 − 6) = | 4 × 90 | f(8 − 2) = | 64 × 10 | 640, Group |
| | | 2⁸⁻⁶ = 4 | (users) = 360 | 2⁸⁻² = 64 | (users) = 640 | (Q) |
| S4, | Object Q3 is selected, | | | | | |
| S5, | the one with least “sequence” value in objects Q3~Q10 | | | | | |
| S6 | (y = 6 for Group(P), y = 3 for group (Q) for next calculation) | | | | | |
| | n = 8 + 1 = 9 = number of selected objects | | | | | |
| S3 | 9 | f(9 − 6) = | 8 × 90 | f(9 − 3) = | 64 × 10 | 720, Group |
| | | 2⁹⁻⁶ = 8 | (users) = 720 | 2⁹⁻³ = 64 | (users) = 640 | (P) |

| | |
|---|---|
| S4, | Object P7 is selected, |
| S5 | n + 1 = 9 + 1 = = k, the one with least “sequence” value in |
| | objects P7~P10 |
| S7 | n = 9, Stopping object voting |

In tables 2A, 2B, and 2C, the score calculation function is an increasing function. The group (P) is an example of more identified users of 90 persons to vote for identical object in each priority, and the group (Q) is an example of fewer identified users with 10 persons to vote another identical object in each priority. For example, in table 2A, the second collected object P2 is determined according to the larger score 90 of group (P) (score 20 of the group (Q) is less), which is based on the score obtained in the first priority, after calculating the result of number of voted identified users multiplied by a function value. From the first collected object to the fourth collected object (P1 to P4), the scores of the group (P) are larger than the scores of the group (Q). However, the fifth collected object (Q1) is determined by group (Q), because the score 160 of group (Q) calculated after collecting the fourth object is larger than the score 90 of group (P). In tables 2A, 2B, and 2C, the number of the collected objects voted by group (P) is seven (collected objects P1, P2, P3, P4, P5, P6, and P7), and the number of the collected objects voted by group (Q) is three (collected objects Q1, Q2, and Q3). That is, even though the more identified users vote the same objects in each round, the fewer identified users can still have chances to determine some collected objects into the discussion block.

Tables 3A, 3B, and 3C illustrate one embodiment of a decreasing function including F(y)=2^{-y}, in a score calculation obtained by multiplying the F(y) function values the number of voted identified users.

TABLE 3A

| | | F(y) | Score | F(y) | Score | Largest score, |
|---|---|---|---|---|---|---|
| | Priority | of Group | of Group | of Group | of Group | group with |
| Step | (n) | (P) | (P) | (Q) | (Q) | largest score |
| S1 | Setting n = 0 | | | | | |
| | setting k = 10 (the number of total objects to be presented in | | | | | |
| | discussion block) | | | | | |
| S2 | Object voting by Group(P) and Group(Q) | | | | | |
| S3 | 0 | F(0) = | 1 × 90 | F(0) = | 1 × 10 | 90, Group |
| | | 2⁻⁰ =1 | (users) = 90 | 2⁻⁰ = 1 | (users) = 10 | (P) |
| S4, | Object P1 is selected, | | | | | |
| S5, | the one with least “sequence” value in objects P1~P10 | | | | | |
| S6 | (y = 1 tor Group(P), y = 0 for group (Q) tor next calculation) | | | | | |
| | n = 0 + 1 = 1 = number of selected objects | | | | | |
| S3 | 1 | F(1) = | 0.5 × 90 | F (0) = | 1 × 10 | 45, Group |
| | | 2⁻¹ = 0.5 | (users) = 45 | 2⁻⁰ = 1 | (users) = 10 | (P) |
| S4, | Object P2 is selected, | | | | | |
| S5, | the one with least “sequence” value in objects P2~P10 | | | | | |
| S6 | (y = 2 for Group(P), y = 0 for group (Q) for next calculation) | | | | | |
| | n = 1 + 1 = 2 = number of selected objects | | | | | |
| S3 | 2 | F(2) = | 0.25 × 90 | F(0) = | 1 × 10 | 22.5, Group |
| | | 2⁻² = 0.25 | (users) = 22.5 | 2⁻⁰ = 1 | (users) = 10 | (P) |

| | |
|---|---|
| S4, | Object P3 is selected, |
| S5, | the one with least “sequence” value in objects P3-P10 |
| S6 | (y = 3 for Group(P), y = 0 for group (Q) for next calculation) |
| | n = 2 + 1 = 3 = number of selected objects |

TABLE 3B

| S3 | 3 | F(−3) = | 0.125 × 90 | F(−0) = | 1 × 10 | 11.25, |
|---|---|---|---|---|---|---|
| | | 2⁻³ = 0.125 | (users) = 11.25 | 2⁻⁰ = 1 | (users) = 10 | Group |
| | | | | | | (P) |
| S4, | Object P4 is selected, | | | | | |
| S5, | the one with least “sequence” value in objects P4~P10 | | | | | |
| S6 | (y = 4 for Group(P), y = 0 for group (Q) for next calculation) | | | | | |
| | n = 3 + 1 = 4 = number of selected objects | | | | | |
| S3 | 4 | F(−4) =2⁻⁴ = | 6.25 × 10⁻² × 90 | F(−0) = | 1 × 10 | 10, Group |
| | | 6.25 × 10⁻² | (users) = 5.625 | 2⁻⁰ = 1 | (users) = 10 | (Q) |
| S4, | Object Q1 is selected, | | | | | |
| S5, | the one with least “sequence” value in objects Q1~Q10 | | | | | |
| S6 | (y = 4 for Group(P), y = 1 for group (Q) for next calculation) | | | | | |
| | n = 4 + 1 = 5 = number of selected objects | | | | | |
| S3 | 5 | F(−4) = 2⁻⁴ = | 6.25 × 10⁻² × 90 | F(−1) = | 0.5 × 10 | 5.625, Group |
| | | 6.25 × 10⁻² | (users) = 5.625 | 2⁻¹ = 0.5 | (users) = 5 | (P) |
| S4, | Object P5 is selected, | | | | | |
| S5, | the one with least “sequence” value in objects P5~P10 | | | | | |
| S6 | (y = 5 for Group(P), y = 1 for group (Q) for next calculation) | | | | | |
| | n = 5 + 1 = 6 = number of selected objects | | | | | |
| S3 | 6 | F(−5) = 2⁻⁵ = | 3.125 × 10⁻² × 90 | F(−1) = | 0.5 × 10 | 5, Group |
| | | 3.125 × 10⁻² | (users) ≈ 2.812 | 2⁻¹ = 0.5 | (users) = 5 | (Q) |

| | |
|---|---|
| S4, | Object Q2 is selected, |
| S5, | the one with least “sequence” value in objects Q2~Q10 |
| S6 | (y = 5 for Group(P), y = 2 for group (Q) for next calculation) |
| | n = 6 + 1 = 7 = number of selected objects |

TABLE 3C

| S3 | 7 | F(−5) = 2⁻⁵ = | 3.12 × 10⁻² × 90 | F(−2) = | 0.25 × 10 | 2.81, Group |
|---|---|---|---|---|---|---|
| | | 3.12 × 10⁻² | (users) ≈ 2.81 | 2⁻² = 0.25 | (users) = 2.5 | (P) |
| S4, | Object P6 is selected, | | | | | |
| S5, | the one with least “sequence” value in objects P6~P10 | | | | | |
| S6 | (y = 6 for Group(P), y = 2 for group (Q) for next calculation) | | | | | |
| | n = 7 + 1 = 8 = number of selected objects | | | | | |
| S3 | 8 | F(−6) = 2⁻⁶ | 1.56 × 10⁻² × 90 | F(−2) = | 0.25 × 10 | 2.5, Group |
| | | 1.56 × 10⁻² | (users) ≈ 1.405 | 2⁻² = 0.25 | (users) = 2.5 | (Q) |
| S4, | Object Q3 is selected, | | | | | |
| S5, | the one with least “sequence” value in objects Q3~Q10 | | | | | |
| S6 | (y = 6 for Group(P), y = 3 for group (Q) for next calculation) | | | | | |
| | n = 8 + 1 = 9 = number of selected objects | | | | | |
| S3 | 9 | F (−6) =2⁻⁶ = | 1.56 × 10⁻² × 90 | F(−3) = | 0.125 × 10 | 1.405, Group |
| | | 1.56 × 10⁻² | (users) ≈ 1.405 | 2⁻³ = 0.125 | (users) = 1.25 | (P) |

| | |
|---|---|
| S4, | Object P7 is selected, |
| S5 | n + 1 = 9 + 1 = k, the one with least “sequence” value in |
| | objects P7~P10 |
| S7 | n = 9, Stopping object voting |

In the tables 3A, 3B and 3C, a user voting status of the more identified user group (P) and fewer identified user group (Q) , is the same as in the tables 2A, 2B, and 2C. Please refer to the scores of the tables 2A, 2B, and 2C, wherein the scores are increasing together with more collected objects are determined. Differently, the scores of tables 3A, 3B and 3C, are decreasing together with more collected objects are determined. Importantly, the number of the collected objects voted by group (P) is seven (collected objects P1, P2, P3, P4, P5, P6, and P7), and the number of the collected objects voted by group (Q) is three (collected objects Q1, Q2, and Q3). That is, even though the more identified users (group (P)) vote the same objects, the fewer identified users can still have chances to determine some collected objects into the discussion block.

In the aforementioned embodiment, the scores for selecting objects are valid for a limited period. After the limited period, the score calculation is reset and the priority parameter is initialized to be 0, to restart the operation illustrated in FIG. 6.

The object volume reweighting can be an objective way to balance the volume of minority and majority groups. By changing the reweighting function, modifying volume ratio by topic is possible. In one embodiment, one of the identified user can vote one or at least two objects within a time period (for example, one day, two days, three days, one week, etc.). However, it is preferable that the at least two objects voted by one identified user are separately weighted that the importance of the objects can be distinguished according to the identified user before presenting to the user interface 103. For example, the object collector 102 provides a first object weighting and a second object weighting, according to a sequence of a first object and a second object voted by one of the identified users within the time period for presenting the objects in the user interface, wherein the first object weighting is higher than the second object weighting. For example, the first/second object weightings can be respectively 60%/40%, 70%/30%, or other weighting ratios. The object collector 102 can deter mine which object is to be presented according to these weighting ratios voted to the object. Further, when the one of the identified user votes three objects within the time period, the first/second/third object weightings can be respectively 40%/30%/30%, 50%/30%/20%, 60%/25%/15%, 70%/20%/10%, or other weighting ratios.

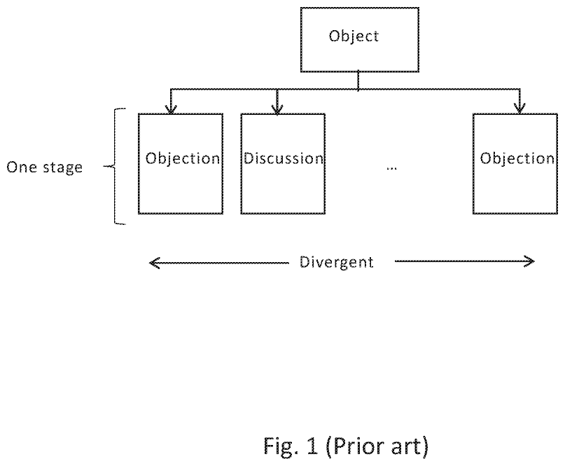

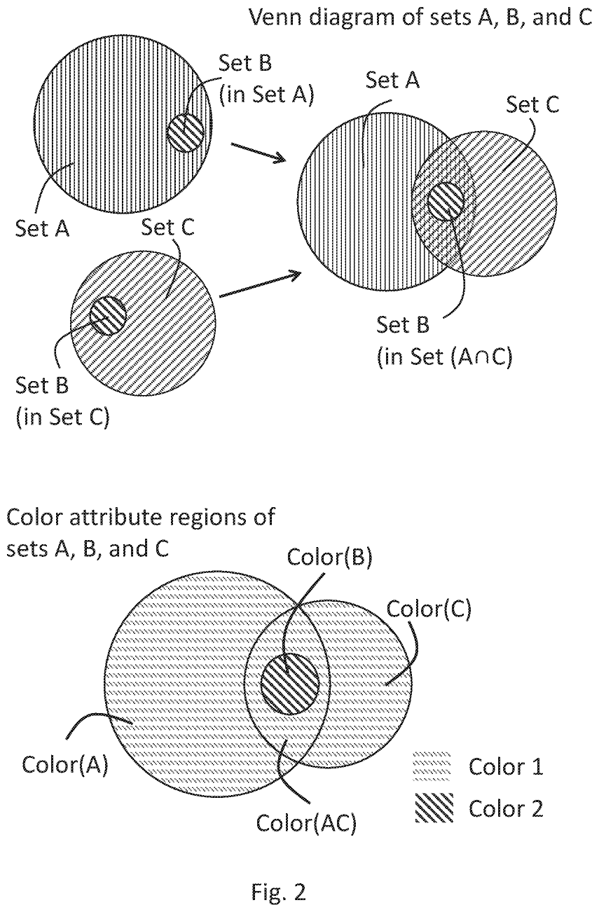

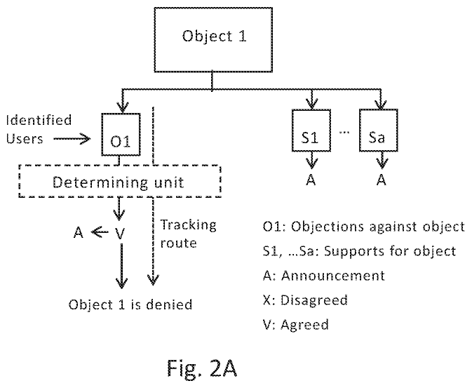

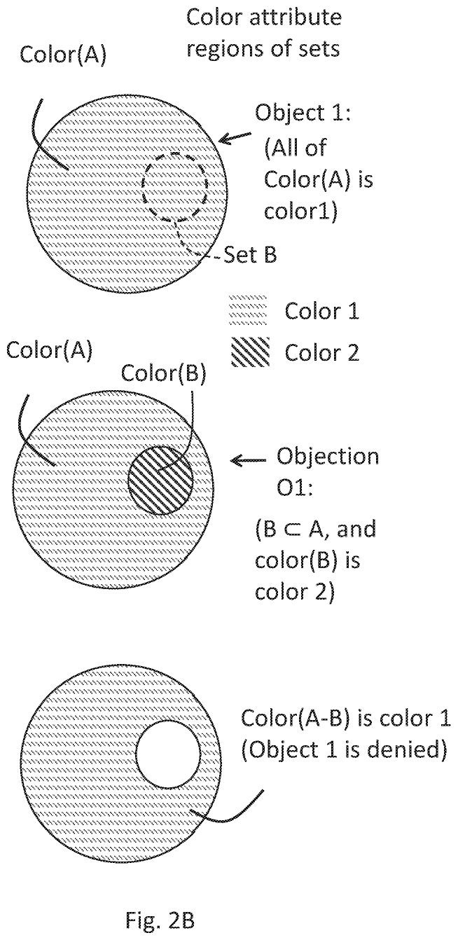

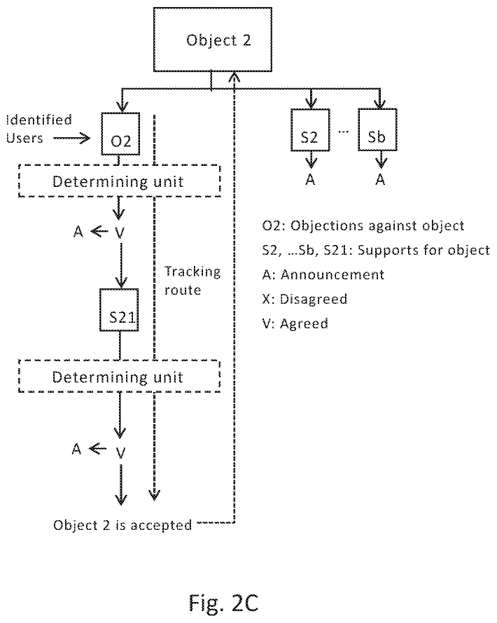

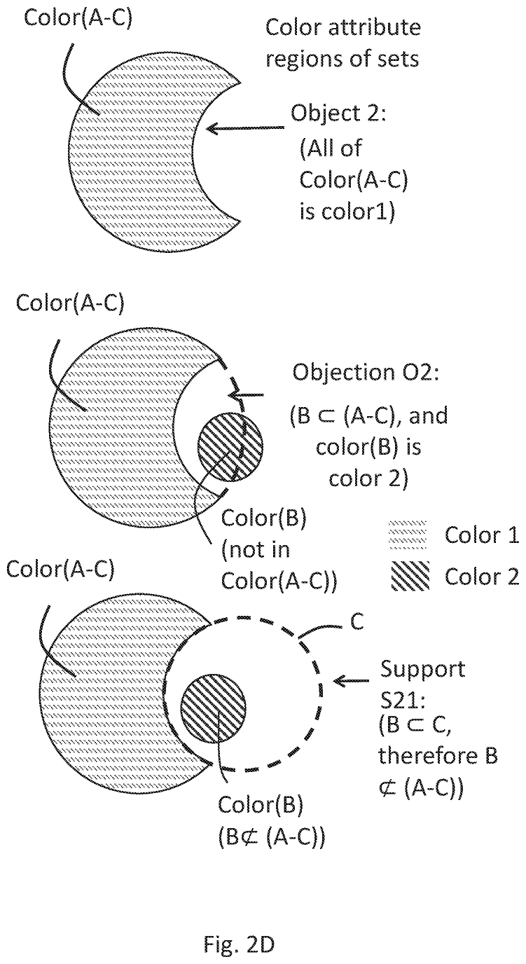

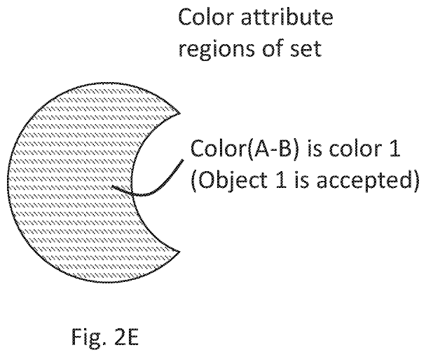

Please refer to FIG. 2, wherein color in a set A (color(A)) includes color 1 and color 2, and color in a set C (color (C)) also includes color 1 and color 2, wherein the color of set B (color(B)) is the color 2. The sets A and C have an intersection (A∩C), which includes color 1 and color 2. Color of a set B is color 2 and the set B are all included in the intersection of set A and set C(A∩C). In order to illustrate how the object rechecking of the present invention is worked, taking one example based on FIG. 2, a collected object 1 is “all of the color in set A is color 1 ”. One of the identified users opposes to this object 1, by providing an objection O1 (FIGS. 1A and 2B), which is “B ⊂A, and color (B) is color 2 (different from the color 1 )”. The objection O1 is approved by determining unit 1032, and the object 1 is accordingly denied, because the color of the set B is not color 1 at the same time and the set B is included in the set A, not all of the colors of the set A is color 1.

Please refer to FIG. 2B, which illustrates the rechecking step of FIG. 2A in a perspective of a set operation. On the top of FIG. 2B, the full circle color(A), corresponds to the object 1 “all of the color(A) is color 1”. On the middle of FIG. 2B, the set B is included in the set A, but the color(B) is color 2. Therefore, the object 1 is denied.

However, based on the original color set combination illustrate in FIG. 2, the operation of the objection rechecking can be in another case. For example, please refer to FIGS. 2C and 2D, a collected object 2 is “all of the color (A-C) is color 1”. One of the identified users opposes to this object 2, by providing an objection O2 (FIGS. 2C and 2D), which is “B ⊂(A-C), and color(B) is color 2”. Accidentally, Objection O2 is falsely agreed by determining unit 1032. However, the set B is not subset of the set (A-C), and one of the identified users may provide a support S21 to the object 2, which is “B ⊂ C, therefore B [symbol] (A-C)”. The support S21 may be agreed in the determining unit 1032, and the conclusion is obtained that the object 2 is accepted.

Please refer to FIG. 2D, which illustrates the rechecking step of FIG. 2C in a perspective of a set operation. On the top of FIG. 2D, the color (A-C) is referred to illustrate the object 2 “all of the color of the set difference (A-C) is color 1”. On the middle of FIG. 2D, the objection O2 provides “the set B is included in the set difference (A-C), but the color(B) is color 1”. In the determining unit 1032, the objection O2 is falsely agreed by voting. After agreeing the objection O2, the identified user further provides the support S21 for the object 2 that “B ⊂ C, therefore B [symbol] (A-C)”. The support S21 is agreed by voting in the determining unit 1032. After the interactive dialectic between the aforementioned object and support, the accepted opinion is “color(A-B) is color 1”, which is the same as the object 2. Meanwhile, with the interactive dialectic between the aforementioned objects and supports, the accepted opinion gradually reduces a scope of the set difference (A-C) to the accepted opinion (FIG. 2E).

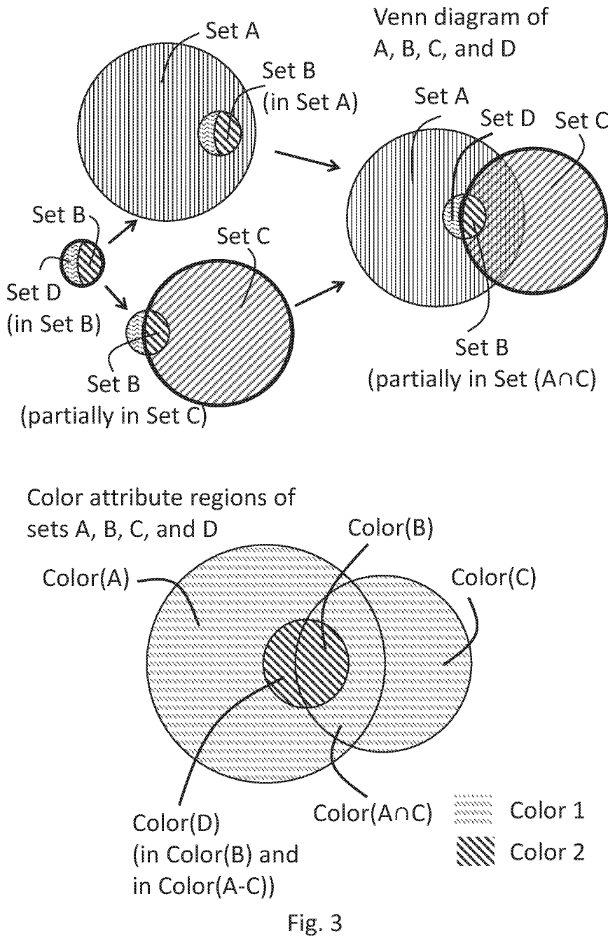

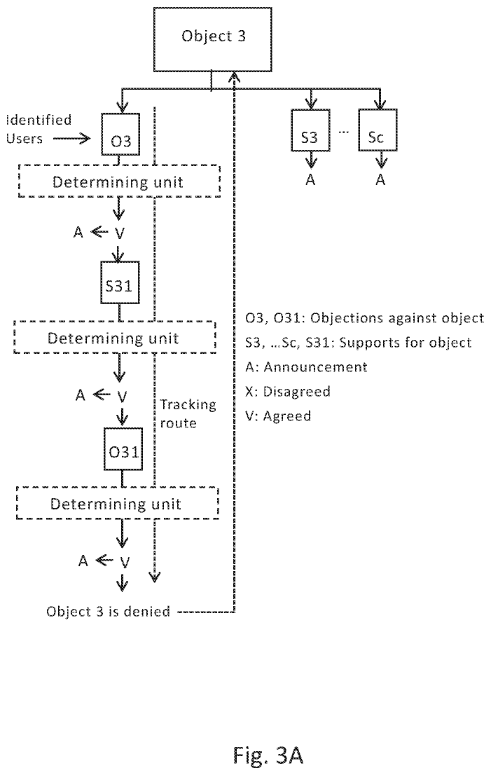

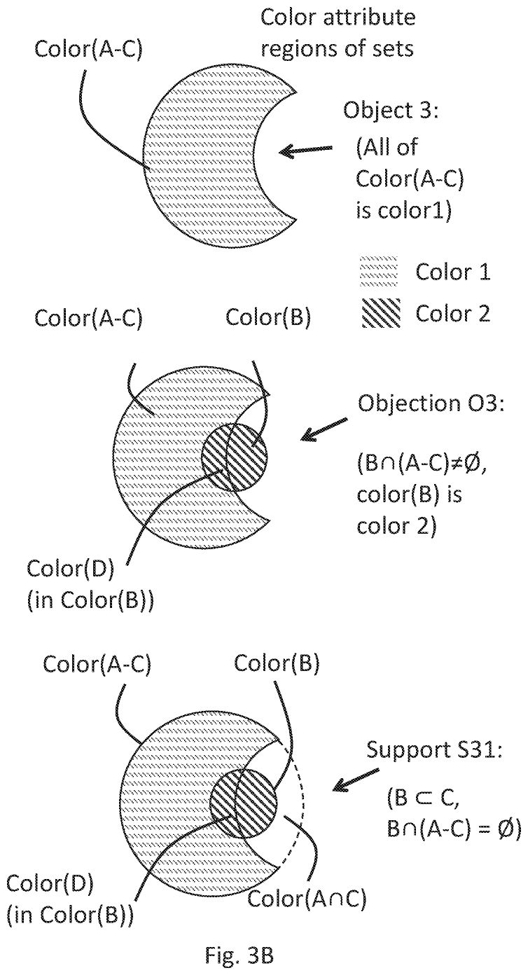

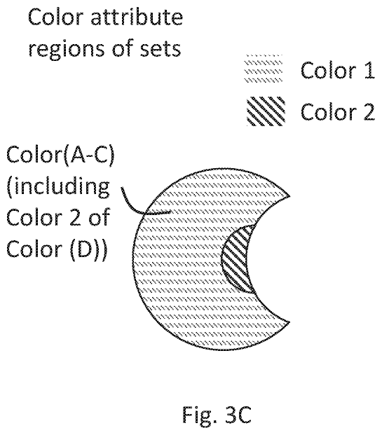

Please refer to FIG. 3, in one embodiment, wherein colors in a set A (color(A)) include color 1 and color 2, and colors in a set C (color(C)) also includes color 1 and color 2. The sets A and C have an intersection (A∩C), which also includes color 1 and color 2. The set B is partially included in the intersection (A∩C) and partially included in the set difference (A-C). The set D is in a portion of the set B in the set difference (A-C). In one embodiment of the object rechecking of the present invention, the collected object 3 is “all of the color (A-C) is color 1”. One of the identified users opposes to this object 3, by providing an objection O3 (FIG. 3A), which is “B∩(A-C)≠Ø, and the color (B) is color 2”. The objection O3 is agreed after the voting step in the determining unit 1032, wherein the set B is partially a subset of the set (A-C). Further, one of the identified users provides the support S31 for the object 3, which is “because B ⊂C, B∩(A-C)=Ø”. The support S31 is falsely agreed in the determining unit 1032. However, the set B is a subset of the set A. One of the identified users still opposes to the object 3, by providing objections O31, which is “because D ⊂A and D [symbol] C, and color(D) is color 2, not all of color (A-C) is color 1”. In the determining unit 1032, the objections O31 agreed, such that the object 3 “all of color (A-C) is color 1 ” is denied.

Please refer to FIGS. 3B and 3C, which illustrate the rechecking step of FIG. 3A in a perspective of a set operation. On the top of FIG. 3B, the color (A-C) corresponds to the object 3 “all of the color (A-C) is color 1 ”. On the middle of FIG. 3B, the objection O3 is “B∩(A-C)≠Ø, color (B)) is color 2”. In the determining unit 1032, the objection O3 is agreed by voting. After agreeing the objection O3, the identified user further provides the support S31 for the object 3 that “because B ⊂C, B∩(A-C)=Ø”. The support S31 is falsely agreed by voting in the determining unit 1032. One of the identified users still opposes to the object 3, by providing objections O31, which is “because D ⊂A and D [symbol] C, and color (D) is color 2, not all of color (A-C) is color 1”. In the determining unit 1032, the objections O31 is agreed, such that the object 3 “all of color (A-C) is color 1” is denied. In short, after these interactive dialectic between the aforementioned objects and supports, the object 3 is denied. Meanwhile, with the iteration through objects and supports, the accepted opinion also reduces an accepted scope of the set corresponding to the object 3.

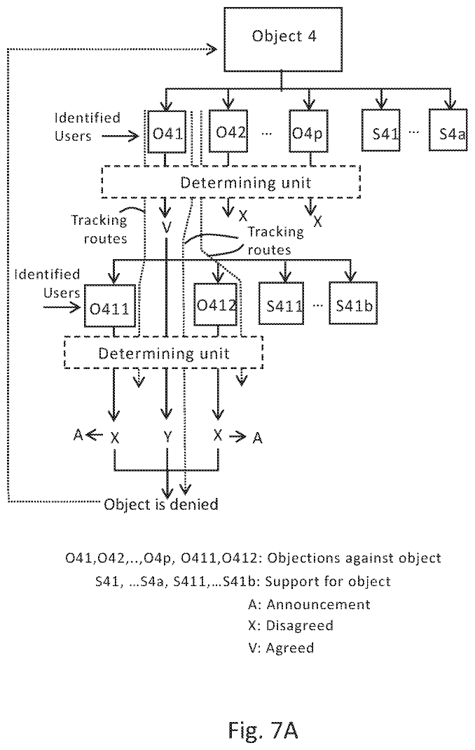

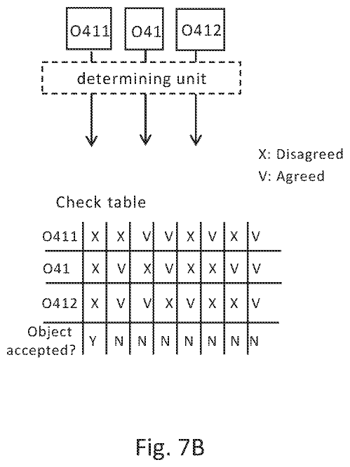

However, the operation of object rechecking can be in a different way. Please refer to FIG. 7A, in one embodiment, wherein one embodiment of the discussion on the object 4 in the discussion block 1031 is illustrated. In FIG. 7A, the objections O41, O42, . . . , O4p are provided by the identified users, to oppose to the object 4. The objections O41, O42, . . . , O4p can be provided to the determination unit 1032 for determining whether these objections are agreed or disagreed. After the voting, decision, the objection O41 is agreed. Importantly, if there is any objection to the objection is not overcome, the object 4 is either denied or classified into unknown. In response to the objection O41, the identified users provide their opinions, such as objections O411, O412, and supports S411, . . . S41b. These objections O411, O412, and supports S411, . . . S41b are substantial for persuading other identified users to accept their opinions during voting in the determination unit 1032. The objections O411 and O412 are the opinions against the object 4, and the supports S411, . . . S41b are the opinions for the object 4. That is, the objections O411 and O412 are the opinions for the objection O1, and the supports S411, . . . S41b are the opinions against the objection O1. After expressing these objections O411 and O412 and supports S411, . . . S41b, the objections O411 and O412 can be voted in the determining unit 1032 for determining to be agreed or disagreed. In FIG. 7A, the objections O411, O412, and O41 is one example of the objections needed to be overcome for accepting the object 4. Because of the agreed decision of the objection O41, the object 4 is denied to be presented in the bulletin 104.

In the embodiments of FIG. 7A, the steps of determining the objections to be agreed or disagreed are one key of determining the object to be accepted or denied. Importantly, the stages in the system are not limited to the aforementioned embodiment of FIG. 7A. Please refer to FIG. 7B, which illustrates examples of determining the object 4 to be accepted or denied, according to the objection determination. FIG. 7B illustrates a check table corresponds to the embodiment of FIG. 7A. In FIG. 7B, it is obvious that only when all of the objections are determined to be disagreed, the object 4 is accepted. In one point of view, the check table of determining the objects to be accepted or not, can be regarded as a logical nor truth table according to agreement/disagreement the objection. For example, the objection disagreement can be regarded as logical “0”, the objection agreement can be regarded as logical “1”, the object denial can be regarded as logical “0”, and the object acceptance can be regarded as logical “1”. In the check table, when the inputs are all objection disagreements (all “0”), the output can be obtained by nor operation to have the object acceptance (“1”) .

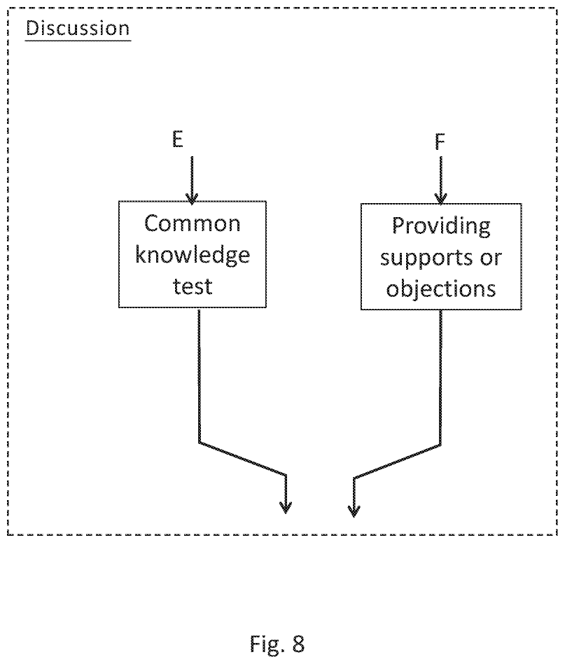

In one embodiment, FIG. 8 illustrates several options for the discussion. In option E, the objection or the supports can be verified by common knowledge test, such that the step of determining the objections and the supports is based on identified users' voting and weightings. In one embodiment, the common knowledge test can be shared to those who are not identified users, and the loading of discussion on the identified users can be alleviated. In option F, the identified users can provide objections or supports related to the objects. When embodying the present invention, the discussion can include at least one of these two options D and E.

In one embodiment, the user interface 103 provides a question bank (FIG. 4), which comprises a predetermined-truth bank, a predetermined-false bank, and a to-determine bank, for respectively storing questions with predetermined-true descriptions, questions with predetermined-false descriptions, and questions with to-determine descriptions. In one embodiment, the user interface 103 further provides a test with questions from the predetermined-truth bank, the predetermined-false bank, and the to-determine bank, to the identified users to answer. By answering the questions, identified users could earn in-system currency or other merits. In one embodiment, one of the merits may be a premium for the in-system currency. For example, the merit can be a multiple of the in-system currency earned by the user. Or, one of the merits can be an account validation for higher ranking the user, the users' objection, or the users' support.

In one embodiment, the identified users can also spend their in-system currency for challenging the accepted/denied result of the objects, the agreed/disagreed result of the objections, or the agreed/disagreed result of the supports, by providing the opinions (objections, support, or any kinds of comment or feedback).

In one embodiment, the public object rechecking system 100 collects the questions with the to-determine descriptions, by extracting logical descriptions from the object, the supports, or the objections. The logical descriptions are then included in the test for collecting corresponding answers from the identified users. When the answers to the logical descriptions are determined according to the collected answers (for example, the majority of the collected answers from the identified users are true, false, unknown, or no response). The logical descriptions with relative majority positive answers can be classified into the predetermined-truth bank, the logical descriptions with relative majority negative answers into the predetermined-false bank, and the logical descriptions with unclear or no answers into the to-examine bank. Therefore, the public object rechecking system 100 of the present invention further provides a function of “question self-feeding and self-verifying”. In one embodiment, the step of extracting logical descriptions from the object, the supports, or the objections, may be operated by AI (artificial intelligence) technology. Or, the step of classifying the logical descriptions with answers into the predetermined-false bank or the predetermined-truth bank, may be operated by AI technology. The AI technology may extract logical descriptions from the object, or collect real-time feedback from user/online resources.

In one embodiment, the public object rechecking system, further comprising a duration period, which starts from the user interface presenting the object, till the object determined to be accepted or denied. Because timeline is usually very important for clarifying the focused object, the duration period is very important to provide the accepted object in time.

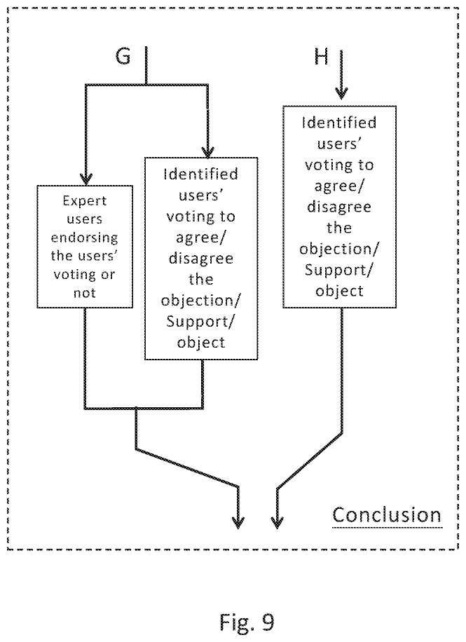

FIG. 9 illustrates several options to obtain the conclusion in the determining unit 1032. In option G, the objection, the decision determination includes at least two steps: the identified users voting to agree/disagree the objections/supports/objects to be accepted (agreed) or denied (disagreed), and the expert users can endorse the user' voting. For example, when the objection is voted by the identified users to be accepted, and the expert users can vote to endorse this user's voting is acceptable or not. When at least one of the expert users votes to endorse the users' voting, it means that the expert users support this users' voting. The option G is the option by providing expert users' support to the voting decision. Options H includes only one option of the voting the objection by the identified users.

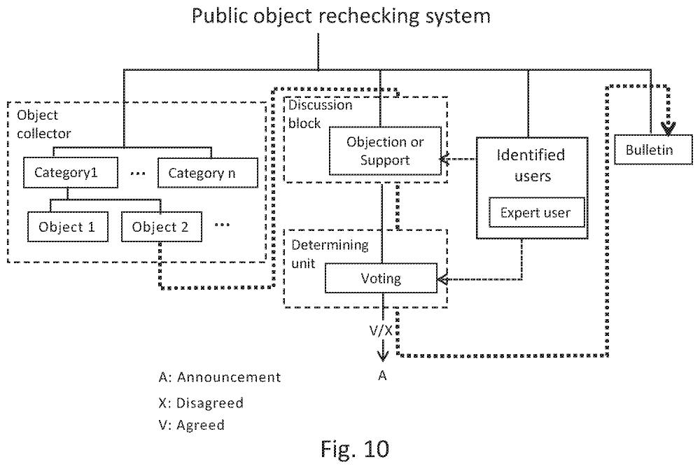

In one perspective, the operation in the user interface 103 can be also illustrated as FIG. 10. First, the objects are classified into different categories (for example, 3 categories, n categories, or other numbers of categories) for presenting objects of different fields in the discussion block to the identified users, that the identified users can choose their interested category for voting or providing the objections or supports. The objects can be submitted to the discussion block, by providing objections (or objections and supports) for determining the object is accepted or denied. The dashed lines illustrate a process of determining the object, wherein the object 2 is accepted according to the user voting in the determining unit 1032. However, the object determination can be in a different way. For example, the object 2 can be also denied because of the user voting in the determining unit.

In one embodiment, the voting in the determining unit 1032, can be weighted by the in-system currency spent by the identified users. For example, when one of the identified users sends a higher in-system currency, his/her vote may be weighted higher according to spent in-system currency. This higher weighting may be used to determine the priority of collecting object (in the object collector 102), the vote in the determining unit 1032, or discussion in the discussion block 1031.

Regarding the obtaining decision in the present invention, the public object rechecking system can briefed into several rules:

1. no “partial truth” in the accepted object. When there is any objection corresponding to the object is determined to be accepted (or not overcome), the whole description of the object is determined to be denied. Importantly, any one of the identified users can choose a part of the object to oppose.

2. any objection, support, object, discussion or decision can be a new object that any of the identified users can oppose to, by providing the opposing objection.

3. when the opposition is raised based on informal fallacy, the section of the object related to this opposition can be isolated from the discussion of this object, into another independent new object.

4. when the users answer the questions from the to-determine bank, the answers are statistically determined to be predetermined-true or predetermined-false. Further, if necessary, the answers can be weighted according to the credit of the users answering the questions.

5. one identified user can choose another user as the expert user for the object.

6. for trustworthy and convenient user management, any of the identified user can be confidential to other users in the system, and the account can be modified easily. No one can have more than one account and the determining unit can easily contact the user when receiving information from the determining unit.

7. not only the conclusion, but any objection, any support, and any object can be discussed based on different opinions.

8. for avoiding malicious answers and reducing the impact of malicious answers, the user can individually distinguish any malicious content mixed in the object, objection, or support. Further, the user who does the mixing can be fined by reducing the credit of the in-system currency.

In one embodiment, before (or after) voting to agree the object, the identified users need to pass a common knowledge test for weighting the voting from the identified users. In one embodiment, the common knowledge test can be an internet robot identification application, such as a series of questions for image interpretations, or the qualification test based on the common knowledge for the skilled persons in the art. For example, the qualification test ca be used to filter the qualified users to do voting based on the specific field art. For example, when one of the identified users does not pass the common knowledge test, the voting can be ignored, weighted at a lower level, or the weighting of voting of this identified user is negative, to avoid misleading of the decision. In one embodiment, the common knowledge test can include the questions from the predetermined-truth bank, the predetermined-false bank, or the to-examine bank. Further, the common knowledge test has a function of verifying the questions from the to-examine bank to be the questions of the predetermined-truth bank or the predetermined-false bank, by mixing the questions from the to-examine bank with the questions of the predetermined-truth bank and the predetermined-false bank, and classifying the questions from the to-exam the bank according to the obtained relative majority positive/negative answers from the identified users. In one embodiment, this question classifying process can be operated by AI technology.

The present invention has been described in considerable detail with reference to certain preferred embodiments thereof. It should be understood that the description is for illustrative purpose, not for limiting the scope of the present invention. Those skilled in this art can readily conceive variations, combinations and modifications within the spirit of the present invention. For example, if necessary, the rechecking process according to the present invention can have a mechanism for the identified users to challenge the results of the objects, the objections, or the support, determined by the determining unit. That is, the results of the objects, the objections, or the support can be rechecked again, if necessary.

What is claimed is:

1. A pubic object rechecking system, comprising:
a user identification unit, identifying a plurality of users for entering the system;
an object collector, located on a server for collecting at least one object;
a user interface, configured to present the object to the identified users in a discussion block for collecting objections to the object, and determining the object to be accepted or denied, according to the objections; and
a bulletin, configured to announce the object determined to be accepted.

2. The public object rechecking system of claim 1, wherein the identified users log in the public object rechecking system by respective account identification.

3. The public object rechecking system of claim 1, wherein the user interface is comprised in an application software, an electronic device, a webpage, a computer, or a multimedia tool.

4. The public object rechecking system of claim 1, wherein the object is determined to be accepted or denied, according to that the identified users vote to determine the object to be accepted or denied, or that at least one expert users of the identified users endorses or does not endorse the identified users' voting.

5. The public object rechecking system of claim 1, wherein the object collector determines the object to be presented in the discussion block by including: determining a number of total objects to be presented in the discussion block; the identified users voting; calculating scores obtained by a function vale based on a number of the identified users voting the object and/or a count of the collected object voted by the identified users; and determining the object to be presented in the discussion block according to the scores.

6. The public object rechecking system of claim 1, wherein the user interface provides a question bank, which comprises a predetermined-truth bank, a predetermined-false bank, and a to-determine bank, for respectively storing questions with predetermined-true descriptions, questions with predetermined-false descriptions, and questions with to-determine descriptions.

7. The public object rechecking system of claim 6, wherein the user interface provides a test with questions from the predetermined-truth bank, the predetermined-false bank, and the to-determine bank, to the identified users for answering the test to earn a credit in an in-system currency.

8. The public object rechecking system of claim 7, wherein the identified users spend a portion of the credit for providing the objection, or voting to determine the object to be accepted or denied.

9. The public object rechecking system of claim 7, wherein the public object rechecking system collects the questions with to-determine descriptions, by extracting logical descriptions from the objects, a plurality of supports, or the objections, wherein the logical descriptions are included in the test for collecting corresponding answers from the identified users, and when the true or false of the logical descriptions are determined according to the collected answers, the logical descriptions are classified into the predetermined-truth bank or the predetermined-false bank.

10. The public object rechecking system of claim 1, further comprising a duration period, which starts from the user interface presenting the object, till the object determined to be accepted or denied.
